(19) United States
(12) Patent Application Publication
(10) Pub. No.: US 2025/0286909 A1
(43) Pub. Date: Sep. 11, 2025

(54) CYBERSECURITY ENFORCEMENT USING SYNTHETIC PHISHING

(71) Applicant: Capital One Services, LLC, McLean, VA (US)

(72) Inventors: Jeremy GOODSITT, Champaign, IL (US); Samuel SHARPE, Cambridge, MA (US); Steven YAO, Sudbury, MA (US); Christopher FERRI, Louisa, VA (US); Brian BARR, Schenectady, NY (US); Michael DAVIS, Arlington, VA (US); Taylor TURNER, Richmond, VA (US); Owen REINERT, Queens, NY (US); Doron BERGMAN, Brambleton, VA (US); James SCHNEIDER, Fairfax, VA (US)

(21) Appl. No.: 18/596,037

(22) Filed: Mar. 5, 2024

(51) Int. Cl. H04L 9/40

(52) U.S. Cl. CPC H04L 63/1483

(57) ABSTRACT

In some implementations, a cybersecurity enforcement system may generate a synthetic phishing attempt targeting a user. The cybersecurity enforcement system may update, based at least in part on a mode of the synthetic phishing attempt, a risk profile specific to the user.

### BACKGROUND

One common form of computer attack is a phishing attempt. A phishing attempt includes a communication, sent to a user, that uses impersonation (or another form of trickery or deception) to entice the user to provide a set of credentials to an attacker.

### SUMMARY

Some implementations described herein relate to a system for cybersecurity enforcement. The system may include one or more memories and one or more processors communicatively coupled to the one or more memories. The one or more processors may be configured to generate a synthetic phishing attempt that targets a user via a communication mode of the synthetic phishing attempt. The one or more processors may be configured to identify a user response or non-response to the synthetic phishing attempt. The one or more processors may be configured to update, based at least in part on the communication mode of the synthetic phishing attempt and the user response or non-response, a risk score specific to the user.

Some implementations described herein relate to a method of cybersecurity enforcement. The method may include generating a synthetic phishing attempt that targets a user via a communication mode of the synthetic phishing attempt. The method may include updating, based at least in part on the communication mode of the synthetic phishing attempt, a risk profile specific to the user.

Some implementations described herein relate to a non-transitory computer-readable medium that stores a set of instructions. The set of instructions comprises one or more instructions that, when executed by one or more processors of a cybersecurity enforcement system, may cause the cybersecurity enforcement system to generate a synthetic phishing attempt that targets a user via a communication mode of the synthetic phishing attempt. The one or more instructions, when executed by one or more processors of the cybersecurity enforcement system, may cause the cybersecurity enforcement system to update, based at least in part on the communication mode of the synthetic phishing attempt, a risk score specific to the user.

### BRIEF DESCRIPTION OF THE DRAWINGS

FIG. 1 is a diagram of an example associated with cybersecurity enforcement using synthetic phishing, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with cybersecurity enforcement using synthetic phishing, in accordance with some embodiments of the present disclosure.

FIG. 4 is a flowchart of an example process associated with cybersecurity enforcement using synthetic phishing, in accordance with some embodiments of the present disclosure.

### DETAILED DESCRIPTION

The following detailed description of example implementations refers to the accompanying drawings. The same reference numbers in different drawings may identify the same or similar elements.

Synthetic phishing can be used to determine user susceptibility to actual phishing attempts. However, phishing attempts can occur via different communication modes (e.g., email, phone, text, or the like), and a given user may be more susceptible to certain communication modes of phishing attempts than other communication modes of phishing attempts. As a result, tracking synthetic phishing attempts without accounting for the communication mode of the synthetic phishing attempt may lead to inaccurate predictions of user susceptibility for a future phishing attempt. For example, if a user is more susceptible to email-based phishing attempts than phone-based phishing attempts, and the user performs well in synthetic phishing attempts that occur over the phone, then a prediction of user susceptibility for email-based phishing attempts may be overestimated. As a result, cybersecurity (e.g., relating to user credentials) may be compromised.

Some implementations described herein enable a user to track a phishing risk associated with a user based on a communication mode of one or more synthetic phishing attempts that target the user. For example, the phishing risk may be tracked using a risk profile (e.g., a risk score) that is specific to the communication mode of the synthetic phishing attempt(s). In some examples, the user may have multiple risk scores corresponding to respective communication modes (e.g., email, phone, text, mail, or the like). For example, the user may have a first risk score associated with a first communication mode, a second risk score associated a second communication mode, and so forth.

As a result, user susceptibility to phishing attempts may be tracked more accurately. For example, if a user is more susceptible to email-based phishing attempts than phone-based phishing attempts, then a prediction of user susceptibility for phone-based phishing attempts may be prevented from causing a prediction of user susceptibility for email-based phishing attempts to be overestimated. Thus, maintaining separate risk scores for individual phishing attempt communication modes may improve accuracy in tracking user susceptibility for each phishing attempt communication mode.

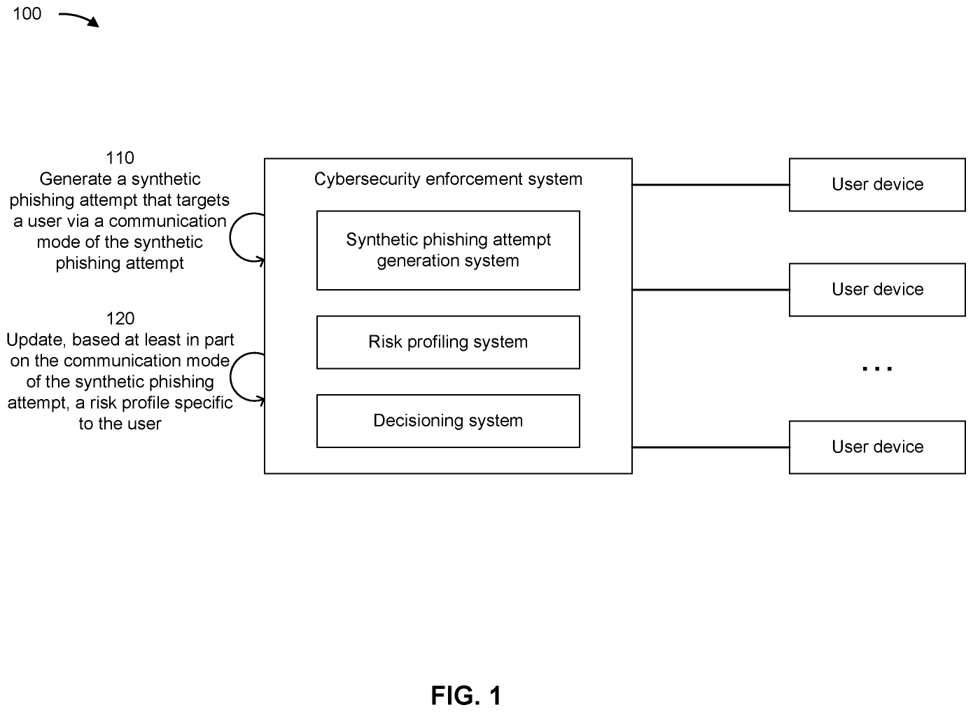

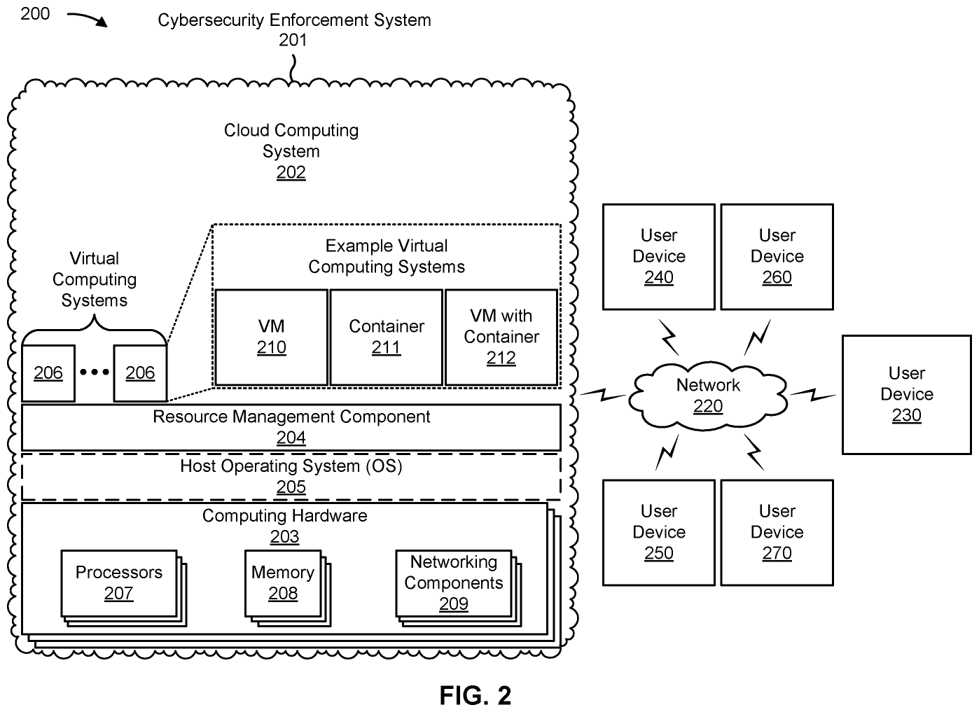

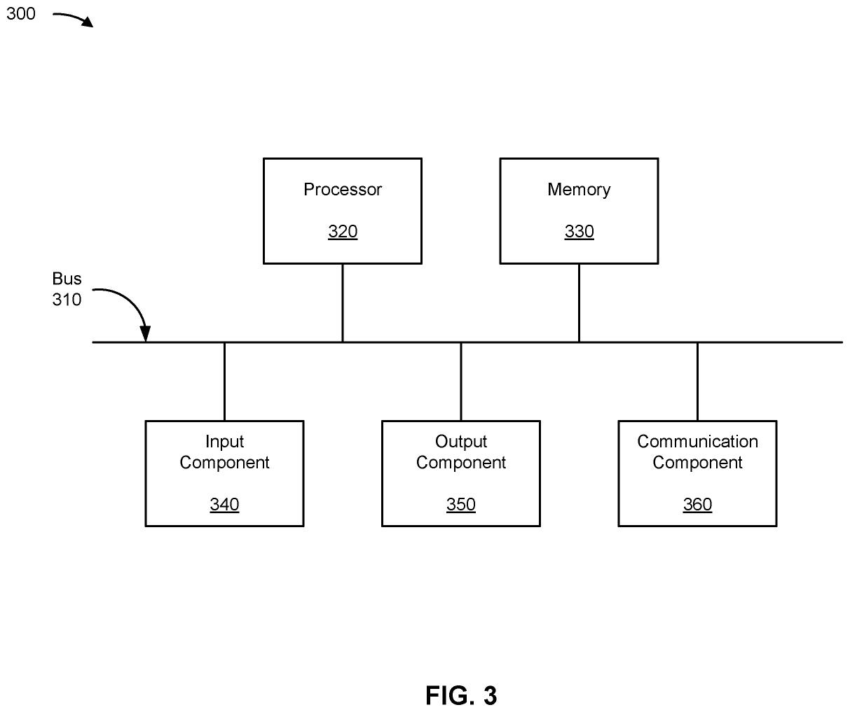

FIG. 1 is a diagram of an example 100 associated with cybersecurity enforcement using synthetic phishing. As shown in FIG. 1, example 100 includes a cybersecurity enforcement system device and a plurality of user devices. These devices are described in more detail in connection with FIGS. 2 and 3.

In some aspects, the cybersecurity enforcement system may receive an indication that the user has opted in to synthetic phishing attempts. The cybersecurity enforcement system (e.g., the risk profiling system) may receive the indication from a user device that is associated with (e.g., used by) the user. The indication may provide a mechanism by which the user can choose to participate in synthetic phishing attempts. For example, the cybersecurity enforcement system may target the user with synthetic phishing attempts in response to receiving the indication. In cases where the cybersecurity enforcement system does not receive the indication, then the cybersecurity enforcement system may refrain from targeting the user with synthetic phishing attempts.

In some aspects, as shown by reference number 110, the cybersecurity enforcement system (e.g., the synthetic phishing attempt generation system) may generate a synthetic phishing attempt that targets a user via a communication mode of the synthetic phishing attempt. The synthetic phishing attempt may target the user in that the synthetic phishing attempt may include synthetic phishing data that is personalized based on the user and/or in that the synthetic phishing attempt may be sent to the user. The synthetic phishing attempt may target the user via the communication mode in that the communication mode may be a medium or technology by which the synthetic phishing attempt targets the user.

The synthetic phishing attempt generation system may be a generative artificial intelligence (AI) or machine learning (ML) model (e.g., a generative adversarial network (GAN) model or the like) configured to generate the synthetic phishing attempt (e.g., phishing data or content, such as text, images, or the like). For example, the generative AI or ML model may generate synthetic (e.g., artificial, fake, or the like) data to be used for the synthetic phishing attempt. The generative AI or ML model may generate the synthetic phishing attempt based on user behavior (e.g., past transaction data), or the like. In some examples, the generative AI or ML model may be trained on actual or synthetic phishing attempts (e.g., emails, texts, or the like).

In some aspects, the communication mode (e.g., type) of the synthetic phishing attempt may include one or more of email, phone, text (e.g., one or more short message service (SMS) texts), mail, an advertisement on a website, or the like. The communication mode of the synthetic phishing attempt may be a medium by which the synthetic phishing attempt is sent to a user. For example, in cases where the communication mode of the synthetic phishing attempt is phone, the cybersecurity enforcement system may use text-to-voice technology to generate audio of the content generated by the synthetic phishing attempt generation system.

In some examples, the cybersecurity enforcement system may be configured to store, monitor, and/or manage risk profiles of users. A risk profile may include phishing data, specific to the user, that is collected based at least in part on a previous phishing attempt (e.g., a previous synthetic phishing attempt or a previous actual phishing attempt). The phishing data may include one or more of: a time since the previous phishing attempt (e.g., the previous synthetic phishing attempt); user weaknesses or strengths based at least in part on whether or how the user interacted with the previously phishing attempt (e.g., whether the user sent the previous synthetic phishing attempt or a previous actual phishing attempt to a scam-reporting email); a count of communication modes of phishing attempts; a history of previous actual phishing attempts; whether the user historically reports phishing attempts (e.g., as opposed to ignoring the phishing attempts); a difficulty of the previous phishing attempt (e.g., the previous synthetic phishing attempt); or the like. In some examples, the risk profile may include one or more risk scores that represent a probability that the user will (or will not) be tricked by a subsequent phishing attempt. For example, the risk profile may be a vector or matrix of risk scores (e.g., probabilities) for different attributes of the user.

In some aspects, a risk score included in the risk profile may be specific to the communication mode of the synthetic phishing attempt. As a result, the risk profile may be segmented by communication mode. For example, the risk score may correspond to email-based phishing attempts, phone-based phishing attempts, text-based phishing attempts, mail-based phishing attempts, or the like. Thus, the risk score may represent a probability that the user will be tricked by a subsequent phishing attempt of the corresponding communication mode. For instance, if the risk score corresponds to email, then the risk score may represent a probability that the user will be tricked by a subsequent email-based phishing attempt. In some examples, the risk profile may include a plurality of risk scores, each corresponding to a different communication mode of phishing attempts. The risk scores may differ because the user may be tricked more easily via certain communication modes than others.

Additionally, or alternatively, the risk scores may be specific to difficulties of synthetic phishing attempts. Thus, the risk score may represent a probability that the user will be tricked by a subsequent phishing attempt of a given difficulty. For example, a risk score may be specific to “easy,” “medium,” or “difficult” phishing attempts. For example, a first risk score may indicate that the user has a 5% probability of being tricked by an “easy” phishing attempt, a second risk score may indicate that the user has a 50% probability of being tricked by a “medium” phishing attempt, and a third risk score may indicate that the user has a 75% probability of being tricked by a “difficult” phishing attempt. Although this example involves three levels of difficulty (“easy,” “medium,” and “difficult”), the cybersecurity enforcement system may use any suitable quantity of levels of difficulty. In some examples, a given risk score may be specific to both a level of difficulty of a synthetic phishing attempt and the communication mode of the synthetic phishing attempt.

In some aspects, the cybersecurity enforcement system may generate the synthetic phishing attempt based at least in part on a previous phishing attempt targeting the user. For example, the cybersecurity enforcement system may generate the synthetic phishing attempt based at least in part on a risk profile of the user. Based at least in part on the previous phishing attempt targeting the user, the risk profiling system (e.g., one or more AI or ML models) may determine when to send the synthetic phishing attempt to the user, a communication mode of the synthetic phishing attempt, or the like. Thus, the generative AI or ML model may generate the synthetic phishing attempt based at least in part on prompts that are personalized to the risk profile of the user.

In some aspects, the cybersecurity enforcement system may identify a user response or non-response to the synthetic phishing attempt. For example, the cybersecurity enforcement system may identify whether the user called a phone number associated with the synthetic phishing attempt, navigated to a link associated with the synthetic phishing attempt, sent the synthetic phishing attempt to a scam-reporting email, did not interact with or report the synthetic phishing attempt, or the like. Additionally, or alternatively, the cybersecurity enforcement system may identify a time between when the synthetic phishing attempt was sent to the user and the user response, or the cybersecurity enforcement system may identify a time between when the synthetic phishing attempt was sent to the user and an expiration of a time window during which no user response was identified (e.g., a non-response). Additionally, or alternatively, the cybersecurity enforcement system may identify a history of user interactions with previous phishing attempts.

In some aspects, as shown by reference number 120, the cybersecurity enforcement system (e.g., the risk profiling system) may update, based at least in part on the communication mode of the synthetic phishing attempt, a risk profile (e.g., a risk score) specific to the user. For example, the cybersecurity enforcement system may update the risk profile based at least in part on the user response or non-response. For example, the cybersecurity enforcement system may update the risk profile of the user based at least in part on any interaction (or non-interaction) by the user with the synthetic phishing attempt. For example, if the communication mode of the synthetic phishing attempt is email, and the user clicks on a synthetic phishing link in the email, then the cybersecurity enforcement system may update the risk profile to reflect an increase in the probability that the user will be tricked by a subsequent email-based synthetic phishing attempt. For example, the risk score that corresponds to the email communication mode may be increased. Thus, the risk profiling system may be configured to output the risk score (e.g., multiple communication-mode-specific risk scores) for the user based at least in part on the communication mode of the synthetic phishing attempt.

In some examples, the cybersecurity enforcement system may iteratively generate synthetic phishing attempts and update risk profiles or risk scores. For example, upon determining a risk vector (e.g., a vector of risk scores) based at least in part on the synthetic phishing attempt (e.g., communication mode of the synthetic phishing attempt, the user response or non-response, or the like), the cybersecurity enforcement system may determine how or what subsequent synthetic phishing attempt the AI or ML model is to create to further test the user. For example, the risk profiling system may embed the output (e.g., the risk profile or risk score) for use by the synthetic phishing attempt generation system to determine a subsequent synthetic phishing attempt (e.g., a subsequent phishing scheme).

In some aspects, the cybersecurity enforcement system (e.g., a decisioning system of the cybersecurity enforcement system) may perform a cybersecurity action based at least in part on the risk profile (e.g., the risk score). The cybersecurity action may be any suitable action that secures user data (e.g., user credentials or the like). For example, the cybersecurity action may help to prevent the user from being tricked by an actual phishing attempt. The cybersecurity action may include user account changes (e.g., account improvements or restrictions). For example, the cybersecurity action may include one or more of: enabling a given degree of multi-factor authentication, locking the user account or limiting aspects of the user account, limiting user interaction via a phishing attempt communication mode that the user is susceptible to, raising an alert for review of the user account, or the like. For example, in cases where the user is susceptible to link clicks, the cybersecurity enforcement system may lock down Internet (e.g., internet of things (IoT)) interactions more than voice interactions.

In some examples, the risk profiling system may embed the output (e.g., the risk profile or risk score) for the decisioning system, and the decisioning system may use the risk profile or the risk score to identify and/or perform the cybersecurity action. The decisioning system may use a rule, or AI or ML model, to identify the cybersecurity action based at least in part on the risk profile or risk score of the user. For example, the decisioning system may use a rule-based threshold or an ML cluster. The rule-based threshold and/or the ML cluster may apply on a per-communication-mode basis or to all communication modes. In some examples, the decisioning system may use an embedding-based deep learning model to output a classification or score (e.g., risk score) indicating the rule-based threshold. Upon identifying the cybersecurity action from the rule(s) and/or AI or ML model(s), the decisioning system may take the cybersecurity action autonomously or after being approved by an administrator.

Updating the risk profile based at least in part on the communication mode of the synthetic phishing attempt may help to enable accurate tracking of user susceptibility to phishing attempts. For example, if a user is more susceptible to email-based phishing attempts than phone-based phishing attempts, then a prediction of user susceptibility for phone-based phishing attempts may be prevented from causing a prediction of user susceptibility for email-based phishing attempts to be overestimated. Thus, maintaining separate risk scores for individual phishing attempt communication modes may improve accuracy in tracking user susceptibility for each phishing attempt communication mode.

Generating the synthetic phishing attempt based at least in part on a previous phishing attempt targeting the user may help the cybersecurity enforcement system to test the user via communication modes and/or at difficulties appropriate for the user. The risk score being specific to the communication mode of the synthetic phishing attempt may help to enable the cybersecurity enforcement system to track probabilities of user susceptibility for each communication mode.

In some examples, the cybersecurity enforcement system may identify a risk profile or a risk score of a customer of a company using the synthetic phishing attempt targeting the customer. By determining the risk tolerance of customers through synthetic phishing, the cybersecurity enforcement system may help to prevent customers from falling victim to phishing schemes. For example, using the risk profile or the risk score, the cybersecurity enforcement system may determine any risk tolerances or allowances for the customer, which may protect the customer and/or the company. In some examples, the cybersecurity enforcement system may limit user credit.

Additionally, or alternatively, the cybersecurity enforcement system may reward low-risk customers and/or incentivize customers to become low-risk. In some examples, users may be rewarded for avoiding being tricked by the synthetic phishing attempt. For example, user credit limits may be raised, users may receive gifts, or the like. As a result, users may learn, and/or be incentivized, to implement safe practices with respect to phishing attempts.

In some examples, the cybersecurity enforcement system may identify a risk profile or a risk score of a new or potential customer using the synthetic phishing attempt targeting the customer. In some examples, the cybersecurity enforcement system may test the new or potential customer to determine whether to open an account for the customer. For instance, after the customer applies for an account, the cybersecurity enforcement system may send a synthetic phishing attempt and, after a given amount of time during which the customer does not interact with the synthetic phishing attempt, approve the account. In some examples, the cybersecurity enforcement system may test the customer to determine whether to provide credit to the customer. In some examples, the cybersecurity enforcement system may test a customer with an existing account to determine whether to open another account (e.g., for a credit or loan) for the customer.

As indicated above, FIG. 1 is provided as an example. Other examples may differ from what is described with regard to FIG. 1.

FIG. 2 is a diagram of an example environment 200 in which systems and/or methods described herein may be implemented. As shown in FIG. 2, environment 200 may include a cybersecurity enforcement system 201, which may include one or more elements of and/or may execute within a cloud computing system 202. The cloud computing system 202 may include one or more elements 203-212, as described in more detail below. As further shown in FIG. 2, environment 200 may include a network 220, and/or user devices 230-270. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the cybersecurity enforcement system 201 may include one or more elements 203-212 of the cloud computing system 202, may execute within the cloud computing system 202, and/or may be hosted within the cloud computing system 202, in some implementations, the cybersecurity enforcement system 201 may not be cloud-based (e.g., may be implemented outside of a cloud computing system) or may be partially cloud-based. For example, the cybersecurity enforcement system 201 may include one or more devices that are not part of the cloud computing system 202, such as device 300 of FIG. 3, which may include a standalone server or another type of computing device. The cybersecurity enforcement system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The user devices 230-270 may include one or more devices capable of receiving, generating, storing, processing, and/or providing information associated with cybersecurity enforcement using synthetic phishing, as described elsewhere herein. The user devices 230-270 may include a communication device and/or a computing device. For example, the user devices 230-270 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with cybersecurity enforcement using synthetic phishing. The device 300 may correspond to cybersecurity enforcement system 201 and/or user devices 230-270. In some implementations, cybersecurity enforcement system 201 and/or user devices 230-270 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

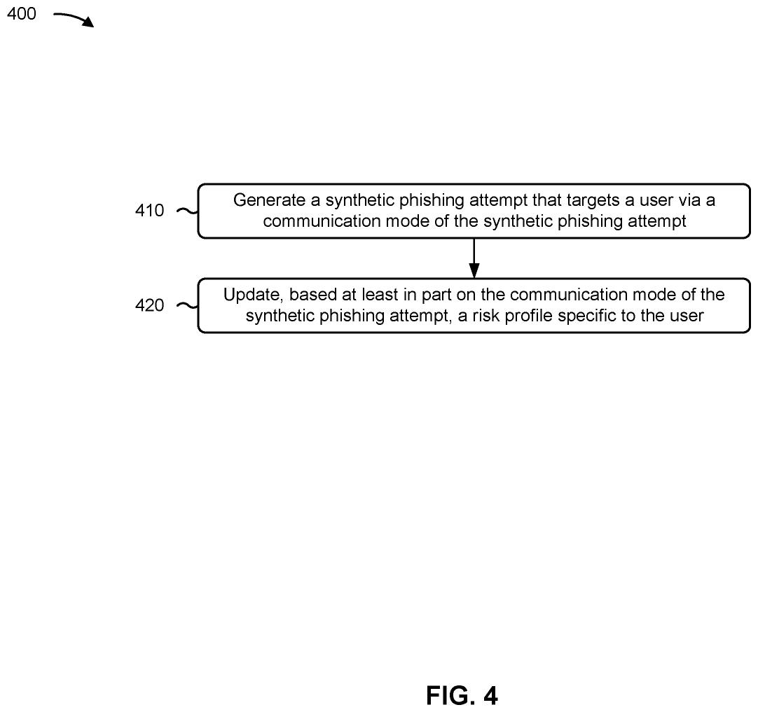

FIG. 4 is a flowchart of an example process 400 associated with cybersecurity enforcement using synthetic phishing. In some implementations, one or more process blocks of FIG. 4 may be performed by the cybersecurity enforcement system. In some implementations, one or more process blocks of FIG. 4 may be performed by another device or a group of devices separate from or including the cybersecurity enforcement system, such as the user devices (e.g., user devices 230-270). Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include generating a synthetic phishing attempt that targets a user via a communication mode of the synthetic phishing attempt (block 410). For example, the cybersecurity enforcement system (e.g., using processor 320 and/or memory 330) may generate a synthetic phishing attempt that targets a user via a communication mode of the synthetic phishing attempt, as described above in connection with reference number 110 of FIG. 1. As an example, the cybersecurity enforcement system may use a generative AI or ML model to generate the synthetic phishing attempt. The synthetic phishing attempt may include text, images, or the like that may be sent to the user via any suitable communication mode (e.g., email, phone, text, mail, or the like).

As further shown in FIG. 4, process 400 may include updating, based at least in part on the communication mode of the synthetic phishing attempt, a risk profile specific to the user (block 420). For example, the cybersecurity enforcement system (e.g., using processor 320 and/or memory 330) may update, based at least in part on the communication mode of the synthetic phishing attempt, a risk profile specific to the user, as described above in connection with reference number 120 of FIG. 1. As an example, if the communication mode of the synthetic phishing attempt is email, and the user clicks on a synthetic phishing link in the email, then the cybersecurity enforcement system may update the risk profile to reflect an increase in the probability that the user will be tricked by a subsequent email-based synthetic phishing attempt. For example, the user may increase the risk score that corresponds to the email communication mode. Thus, the risk profiling system may be configured to output the risk score (e.g., multiple communication-mode-specific risk scores) for the user based at least in part on the communication mode of the synthetic phishing attempt.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIG. 1. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for cybersecurity enforcement, the system comprising:
one or more memories; and
one or more processors, communicatively coupled to the one or more memories, configured to:
generate a synthetic phishing attempt that targets a user via a communication mode of the synthetic phishing attempt;
identify a user response or non-response to the synthetic phishing attempt; and
update, based at least in part on the communication mode of the synthetic phishing attempt and the user response or non-response, a risk score specific to the user.

2. The system of claim 1, wherein the communication mode of the synthetic phishing attempt includes one or more of email, phone, or text.

3. The system of claim 1, wherein the one or more processors are further configured to:
receive an indication that the user has opted in to synthetic phishing attempts.

4. The system of claim 1, wherein the one or more processors are further configured to:
generate the synthetic phishing attempt based at least in part on a previous phishing attempt targeting the user.

5. The system of claim 1, wherein the risk score is specific to the communication mode of the synthetic phishing attempt.

6. The system of claim 1, wherein the one or more processors are further configured to:
perform a cybersecurity action based at least in part on the risk score.

7. A method of cybersecurity enforcement, comprising:
generating a synthetic phishing attempt that targets a user via a communication mode of the synthetic phishing attempt; and
updating, based at least in part on the communication mode of the synthetic phishing attempt, a risk profile specific to the user.

8. The method of claim 7, wherein the communication mode of the synthetic phishing attempt includes one or more of email, phone, or text.

9. The method of claim 7, further comprising:
receiving an indication that the user has opted in to synthetic phishing attempts.

10. The method of claim 7, further comprising:
generating the synthetic phishing attempt based at least in part on a previous phishing attempt targeting the user.

11. The method of claim 7, wherein updating the risk profile includes updating the risk profile based at least in part on a user response or non-response to the synthetic phishing attempt.

12. The method of claim 7, wherein the risk profile includes a risk score that is specific to the communication mode of the synthetic phishing attempt.

13. The method of claim 7, further comprising:
performing a cybersecurity action based at least in part on the risk profile.

14. A non-transitory computer-readable medium storing a set of instructions, the set of instructions comprising:
one or more instructions that, when executed by one or more processors of a cybersecurity enforcement system, cause the cybersecurity enforcement system to:
generate a synthetic phishing attempt that targets a user via a communication mode of the synthetic phishing attempt; and
update, based at least in part on the communication mode of the synthetic phishing attempt, a risk score specific to the user.

15. The non-transitory computer-readable medium of claim 14, wherein the communication mode of the synthetic phishing attempt includes one or more of email, phone, or text.

16. The non-transitory computer-readable medium of claim 14, wherein the one or more instructions further cause the cybersecurity enforcement system to:
receive an indication that the user has opted in to synthetic phishing attempts.

17. The non-transitory computer-readable medium of claim 14, wherein the one or more instructions further cause the cybersecurity enforcement system to:
generate the synthetic phishing attempt based at least in part on a previous phishing attempt targeting the user.

18. The non-transitory computer-readable medium of claim 14, wherein the one or more instructions, that cause the cybersecurity enforcement system to update the risk score, cause the cybersecurity enforcement system to update the risk score based at least in part on a user response or non-response to the synthetic phishing attempt.

19. The non-transitory computer-readable medium of claim 14, wherein the risk score is specific to the communication mode of the synthetic phishing attempt.

20. The non-transitory computer-readable medium of claim 14, wherein the one or more instructions further cause the cybersecurity enforcement system to:
perform a cybersecurity action based at least in part on the risk score.
